(19) United States
(12) Patent Application Publication
(10) Pub. No.: US 2014/0256170 A1
(43) Pub. Date: Sep. 11, 2014

(54) SCREWLESS TERMINAL BLOCK

(71) Applicant: Liang-Chih Cheng, New Taipei City (TW)

(72) Inventor: Liang-Chih Cheng, New Taipei City (TW)

(21) Appl. No.: 13/792,169

(22) Filed: Mar. 10, 2013

(51) Int. Cl. H01R 13/62

(52) U.S. Cl. CPC H01R 13/62
USPC 439/345

(57) ABSTRACT

The screwless terminal block includes an insulative body, a base, a pressing sheet and a releaser. The insulative body is hollow and formed with two lateral through holes in alignment with each other. The base is received in the insulative body and has two ends corresponding to the two lateral through holes. The pressing sheet is received in the base and engages with the base to form two electrical contacts. The releaser is mounted on the base and provided with two release keys. A top end of the release key is protrudent from the insulative body and a bottom end thereof is provided with a pushing portion abutting against the pressing sheet. When the release key is pressed, the pushing portion will press the pressing sheet to move away from the base and the conductive wire clamped between the pressing sheet and the base will be released.

### FIELD OF THE INVENTION

The present invention is related to terminal blocks, particularly to terminal blocks without using screws.

### BACKGROUND OF THE INVENTION

It is well known that a breaker is associated with a terminal block, which is a connector mounted on an electric equipment and used for enabling the electric equipment to be connected with connecting lines of a host.

A typical terminal block comprises an insulative body, a plurality of conductive holders and a plurality of screws. In this case, the insulative body is formed therein with a plurality of receiving rooms, on the top end of each of which a through hole is provided, the insulative body being provided at each of two sides thereof with a lateral through hole communicated with the receiving room, respectively. Each of the conductive holders is mounted in each of the receiving rooms of the insulative body, as well as provided at the top end thereof with a threaded hole and at the side thereof with an opening communicated with the lateral through hole of the insulative body. Each of the screws is screwed to the threaded hole of the conductive holder.

When the terminal block is used, a connecting line of the host may be extended into an opening of the conductive holder through the lateral through hole of the insulative body, followed by screwedly turning each of the screws downward by a screw driver, such that the connecting line of the host may be fastened to each of the conductive holders by each of the downward screws. Thereby, the electric equipment is allowed to be electrically connected to the host.

Although the conventional wiring switch may be connected to the connecting line of the host to electrically connect the electric equipment with the host, the screw driver must be used for fastening the screws so as to screwedly fastening the connecting line of the host by means of the screws. Thus, inconvenience due to screwedly turning the screws by means of the screw driver in a narrow space with difficulty may occur when the electric equipment is mounted in the narrow space (such as, in the ceiling, for example), as well as danger due to bad connection or electrical short may be likely to emerge if the fastening of the screws is not tight.

It is apparent that above conventional one is truly not a satisfactory design with a lot of drawbacks, and thus should be improved desirably.

### SUMMARY OF THE INVENTION

It is one object of the present invention to provide a screwless terminal block, in which manually wiring without the need for hand tools is allowed when the connection of an electric equipment is desired.

It is another object of the present invention to provide a screwless terminal block, in which electrical connection between conductive wires having various materials, various thickness, single core and multicore is applicable when the connection of an electric equipment is desired.

In accordance with above objects, a screwless terminal block of the present invention includes an insulative body, a plurality of bases, a plurality of pressing sheets and a plurality of releasers. The insulative body is hollow and formed with two lateral through holes in alignment with each other. The base is received in the insulative body and has two ends corresponding to the two lateral through holes. The pressing sheet is received in the base and engages with the base to form two electrical contacts. The releaser is mounted on the base and provided with two release keys. A top end of the release key is protrudent from the insulative body and a bottom end thereof is provided with a pushing portion abutting against the pressing sheet. When the release key is pressed, the pushing portion will press the pressing sheet to move away from the base and the conductive wire clamped between the pressing sheet and the base will be released.

### BRIEF DESCRIPTION OF DRAWINGS

FIG. 1 is a perspective view of the present invention;

FIG. 2 is an exploded view of the present invention;

FIG. 3 is an exploded view of the base, the pressing sheet and the releaser of the present invention;

FIG. 4 is a schematic assembled view of the present invention;

FIG. 5 is a schematic plan view of the base, the pressing sheet and the releaser of the present invention;

FIG. 6 is a schematic view illustrating a wire clamped between the base and the pressing sheet; and

FIG. 7 is a schematic view illustrating the use of the present invention.

### DETAILED DESCRIPTION OF THE INVENTION

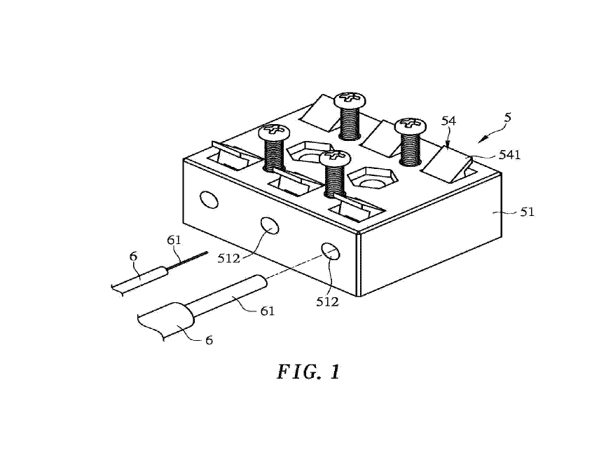

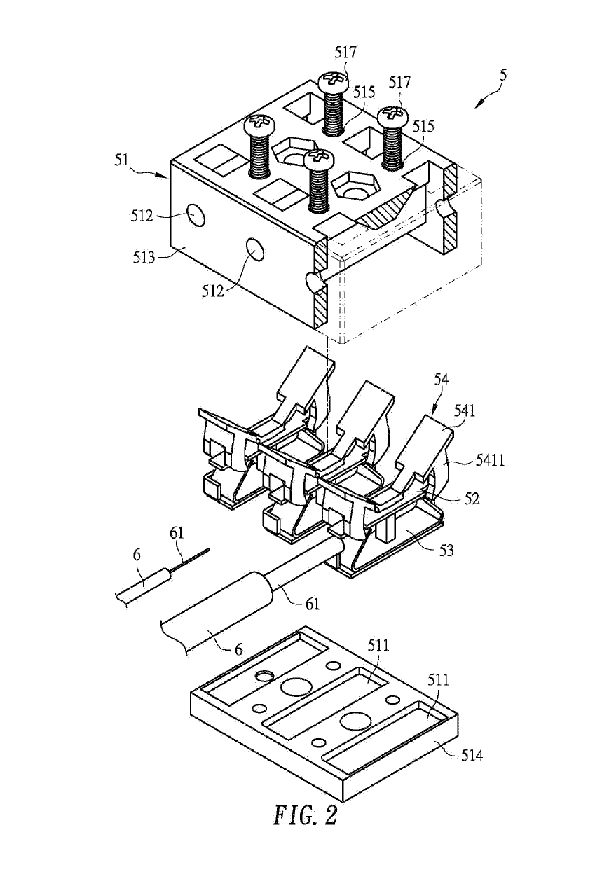

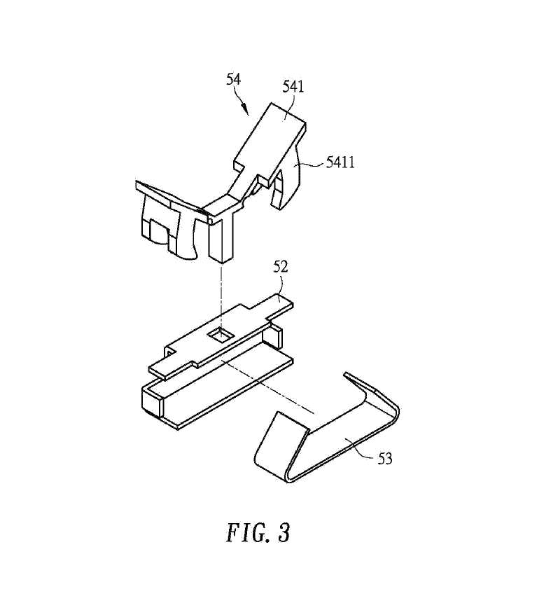

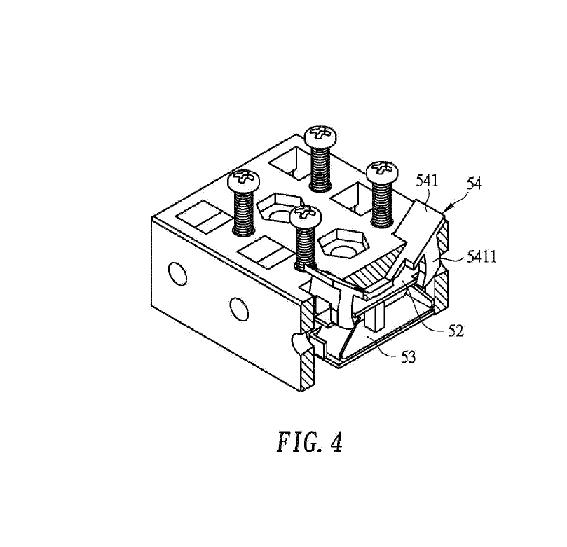

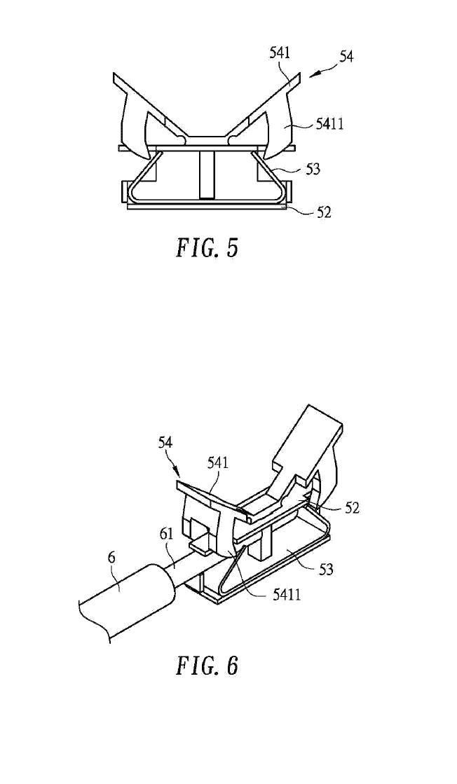

As shown in FIGS. 1 to 6, a screwless terminal block 5 of the present invention includes an insulative body 51, a plurality of bases 52, a plurality of pressing sheets 53 and a plurality of releasers 54. Of course, the quantity of the bases 52, pressing sheets 53 or releaser 54 may be one.

In this case, the insulative body 51 is formed therein with a plurality receiving rooms 511. At each of two sides of the insulative body 51, there is individually provided with a lateral through hole 512 which, communicated with the receiving room 511, respectively, is used for allowing a conductive wire to be disposed therein.

Each of the bases 52 is made of electrically conductive material (such as, electrically conductive metal (copper, iron, aluminum and so on)), and received in the corresponding receiving room 511 with two ends corresponding to the two lateral through holes 512 of the insulative body 51.

Each of the pressing sheets 53 is mounted in each of the bases 52, respectively, in such a way that two ends of each pressing sheet 53 may be formed as electrical contacts.

Each of the releasers 54 is mounted on top of each of the bases 52, and provided at each of two ends thereof with a release key 541, respectively. The top end of each of the buttons 541 is projected upward out of the insulative body 51, while the bottom end thereof is extendingly provided with a pushing portion 5411, by which the pressing sheet 53 clamping a conductive wire 6 may be pushed away when the release key 541 is pressed.

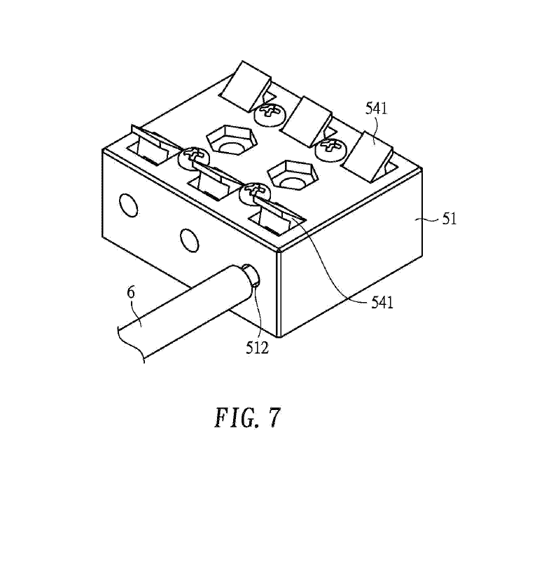

When an assembly of above members, as shown in FIGS. 6 and 7, is used, each of two conductive wires 6 desired to be electrically interconnected may be inserted manually into the corresponding one of the two lateral through holes 512 of the insulative body 51, allowing conductors 61 of the two conductive wires 6 to be clamped at two ends of the pressing sheet 53, respectively, and then electrically interconnected due to the fact that the bases 52 are made of electrically conductive materials.

Furthermore, when the disconnection of the conductive wire 6 from the pressing sheet 53, and then, drawing the conductive wire 6 out of the insulative body 51 are desired, it is only required to press the release key 541, allowing the pushing portion 5411 of the release key 541 to push the pressing sheet 53, clamping the conductive wire 6, away.

As such, manually wiring without the need for hand tools is allowed when the connection of the electric equipment 6 is desired. Moreover, electrical connection between conductive wires having various materials, various thickness, single core and multicore is applicable due to the design of the pressing sheet 53 clamping the conductive wire 6, when the connection of the electric equipment 6 is desired.

Referring to FIGS. 1 to 6 again, the insulative body 51 is constituted by the assembly of an upper body 513 and a lower body 514. The upper body 513 and the lower body 514 may be provided with at least one through hole 515 and threaded hole 516, respectively. The upper body 513 and the lower body 514, formed as the top part and the bottom part, may be fastened together by means of several screws 517 passing through the through hole 515 and screwedly fastening to the threaded hole 516.

Referring to FIGS. 1 to 6 again, the releaser 54 may be made of plastic steel (POM).

Referring to FIGS. 1 to 6 again, the pressing sheet 53 may be formed into a U-shape.

The screwless terminal block provided by the present invention, as compared with that of prior art described above, further comprises merits as follows:

1. Manually wiring without the need for hand tools is allowed when the connection of the electric equipment is desired.

2. The problem of bad connection or electrical short resulted from insufficient tightness in the fastening of screws may be also avoided by manually wiring.

3. Electrical connection between conductive wires having various materials, various thickness, single core and multicore is applicable when the connection of the electric equipment is desired.

To sum up, the screwless terminal block of the present invention is truly provided with a novel construction which, having been never seen before, is neither published, nor found on the market as any similar products. Thus, novelty should be achieved without doubt. Additionally, advancement is provided in the present invention rather than in the conventional one, due to the fact that the conventional one is hardly comparable with the present invention having specific features and functions. Therefore, the essential conditions for patentability is complied with, and the patent application is filed accordingly.

The foregoing description is only the most preferred embodiment of the present invention, but the structural feature of the present invention is not limited thereto. It would be appreciated by those skilled in the art that variations or modifications may be contemplated readily without departing from the following claims of the invention.

What is claimed is:

1. A screwless terminal block comprising:
an insulative body, being hollow and formed with two lateral through holes separately located on two opposite sides thereof and in alignment with each other;
a base, made of a conductive material, received in the insulative body, and having two ends corresponding to the two lateral through holes;
a pressing sheet, received in the base, made of a conductive material, and engaging with the base to form two electrical contacts separately corresponding to the lateral through holes for clamping a conductive wire inserted into one of the lateral through holes; and
a releaser, mounted on a top of the base, being provided with two release keys, a top end of each of the release keys being protrudent from the insulative body, a bottom end of each of the release keys being provided with a pushing portion abutting against the pressing sheet, wherein when one of the release keys is pressed, the pushing portion will press the pressing sheet to move away from the base and the conductive wire clamped between the pressing sheet and the base will be released.

2. The screwless terminal block according to claim 1, wherein the insulative body is constituted by the assembly of an upper body and a lower body, the upper body and the lower body being provided with at least one through hole and threaded hole, respectively, the upper body and the lower body formed as a top part and a bottom part being fastened together by means of several screws passing through the through holes and screwedly fastening to the threaded hole.

3. The screwless terminal block according to claim 1, wherein the pressing sheet is of a U-shape.

4. The screwless terminal block according to claim 1, wherein the conductive material is metal.
